(19) United States
(12) Patent Application Publication
(10) Pub. No.: US 2023/0150391 A1
(43) Pub. Date: May 18, 2023

(54) CONTRACT MANAGEMENT SYSTEM AND CONTRACT MANAGEMENT METHOD

(71) Applicant: HONDA MOTOR CO., LTD., Tokyo (JP)

(72) Inventors: Toru Kimura, OFFENBACH/AM MAIN (DE); Martin Kopp, OFFENBACH/AM MAIN (DE); Christian Koebel, OFFENBACH/AM MAIN (DE); Hisashi Nagaoka, OFFENBACH/AM MAIN (DE)

(21) Appl. No.: 17/974,614

(22) Filed: Oct. 27, 2022

(30) Foreign Application Priority Data
Nov. 17, 2021 (JP) 2021-187100

(51) Int. Cl. B60L 53/68; H04L 9/00; B60L 53/66

(52) U.S. Cl. CPC B60L 53/68; H04L 9/50; B60L 53/665; H04L 2209/84

(57) ABSTRACT

A contract management system including a plurality of computers that operate such that each computer holds the same distributed ledger and a plurality of terminal apparatuses includes: a ledger management unit that records a block including received transaction data in the distributed ledger; and an association-information management unit that, when the ledger management unit records in the distributed ledger a block including transaction data including a smart contract for execution of a contract, generates association information that associates a contract address where the smart contract is stored with contract identification information.

### INCORPORATION BY REFERENCE

The present application claims priority under 35 U.S.C.§ 119 to Japanese Patent Application No. 2021-187100 filed on Nov. 17, 2021 The content of the application is incorporated herein by reference in its entirety.

### BACKGROUND OF THE INVENTION

### Field of the Invention

The present invention relates to a contract management system and a contract management method using a smart contract.

### Description of the Related Art

There have been known smart contract techniques as mechanisms that automatically execute a contract such as a transaction, on a blockchain. A smart contract includes a program used for contract execution, a plurality of computers called nodes (hereinafter, node computers) store the same distributed ledgers, and the smart contract becomes executable when a block storing the smart contract is recorded in the same distributed ledgers. The block recorded in the distributed ledgers may include not only the smart contract but also transaction data which is various kinds of data indicating transaction actions and the like.

The blocks are linked to one another by one block holding the hash value of the data of the previous block. With this configuration, for example, various transaction actions from conclusion to execution of a contract are recorded in a chain of the above linked blocks, in other words, a blockchain, with high reliability. Hereinafter, the statement that information is “recorded in a blockchain” or “recorded in distributed ledgers” means that a block including transaction data including the information is recorded in the distributed ledgers.

Since a smart contract recorded in a blockchain is automatically processed without a third party's intervention, it is possible to prevent falsification of contract content and execute contracts with high security.

However, since in a blockchain system, a smart contract once described in a block cannot be modified later, contract condition changes after conclusion can be a hindrance factor to use of smart contracts.

To resolve this issue, International Publication No. WO2020/213678 discloses a method of controlling a blockchain system in which in the case in which after a smart contract of a concluded contract is recorded in a blockchain, a clause is added to the content of the contract, the contract after the clause is added can be automatically executed as a smart contract.

In this control method, a first smart contract for execution of a concluded contract includes the content of the contract (main contract), a temporary variable to identify a second smart contract for the sub-contract that can be generated in the case in which an additional clause (sub-contract) is generated after that, and the conditions (generation permission conditions) that allow the second smart contract to be generated. Examples of the above generation permission conditions include a condition that the author of transaction data of the second smart contract is a contracting party of the above contract.

Then, when a sub-contract is concluded, and a block including the second smart contract is generated and recorded in the distributed ledgers, next, a third smart contract is generated including the content of the above main contract included in the first smart contract and the place where the second smart contract for the sub-contract is stored, and the generated third smart contract is recorded in the distributed ledgers. With this operation, for example, the terminal apparatus of the user who is one contracting party of the above contract can automatically execute the latest contract content including the main contract and the sub-contract by operating the third smart contract.

### SUMMARY OF THE INVENTION

However, in the above conventional control method, in order that the user seeking to execute a contract executes the third smart contract including the latest sub-contract concluded after the main contract, the user needs to manually change the address (contract address) of the smart contract to be used from the contract address of the first smart contract to the contract address of the third smart contract, using the terminal apparatus of the user.

For this reason, for example, in a case in which the contract condition can change dynamically according to the market situation, such as a fuel price condition in a vehicle fueling contract, every time the fuel price changes, the user needs to manually change the contract address stored in the terminal apparatus to the contract address of the third smart contract of a newly generated sub-contract including the latest fuel price, and this is troublesome.

In light of the above background, an object of the present invention is to provide a highly convenient contract management system in which increase in the number of manual operations is prevented on the terminal apparatus of the user that executes a contract even in a case in which the contract conditions frequently change.

The above object is related to contract execution using the blockchain which is becoming a social infrastructure, and it is possible to achieve fair accessibility usable to the users with low IT literacy by simplifying the user operation and contribute to realization of a sustainable society (SDGs 8.10, 9.1, 10.2).

An aspect of the present invention is a contract management system including a plurality of computers that operate such that each computer holds the same distributed ledger and a plurality of terminal apparatuses, the contract management system including: a ledger management unit that receives transaction data and records a block including the received transaction data in the distributed ledger; and an association-information management unit that, when the ledger management unit records in the distributed ledger a block including transaction data including a smart contract for execution of a contract, generates association information that associates a contract address where the smart contract is stored with contract identification information for identifying the contract.

In another aspect of the present invention, the association-information management unit, when receiving a deletion instruction to delete the association information from one of the terminal apparatuses, deletes the association information specified by the deletion instruction, when receiving an invalidation instruction to invalidate the association information from the one terminal apparatus, invalidates the association information specified by the invalidation instruction, and/or when receiving a validation instruction to validate the association information from the one terminal apparatus, validates the association information specified by the validation instruction.

In another aspect of the present invention, when the association-information management unit generates, deletes, invalidates, or validates the association information, the association-information management unit generates transaction data on the generation, deletion, invalidation, or validation of the association information, and the ledger management unit records a block including the generated transaction data in the distributed ledger.

In another aspect of the present invention, the one terminal apparatus is an operator terminal apparatus that is operated by an operator certified for management of the smart contract.

In another aspect of the present invention, the association-information management unit transmits a contract address of a valid smart contract to be used for executing the contract to the terminal apparatus seeking to execute the contract, based on the association information.

In another aspect of the present invention, the smart contract is on a contract for electric power transaction by charging and discharging a battery mounted on a vehicle, and the terminal apparatus seeking to execute the contract is a mobile terminal owned by a user of the vehicle or a terminal apparatus mounted on the vehicle.

Another aspect of the present invention is a contract management method performed by a contract management system including a plurality of computers that operate such that each computer holds the same distributed ledger and a plurality of terminal apparatuses, the contract management method including: recording in the distributed ledger a block including transaction data including a smart contract for execution of a contract; and generating association information that associates a contract address where the smart contract is stored with contract identification information for identifying the contract, and storing the generated association information.

With an aspect of the present invention, it is possible to provide a highly convenient contract management system in which increase in the number of manual operations is prevented on the terminal apparatus of the user that executes a contract even in a case in which the contract conditions can frequently change.

### BRIEF DESCRIPTION OF THE DRAWINGS

FIG. 1 is a diagram illustrating the configuration of a contract management system according to an embodiment of the present invention;

FIG. 2 is a diagram illustrating an example of the configuration of a node computer;

FIG. 3 is a diagram illustrating an example of the configuration of a first contracting-party terminal;

FIG. 4 is a diagram illustrating an example of the configuration of a second contracting-party terminal;

FIG. 5 is a diagram illustrating an example of the configuration of an operator terminal;

FIG. 6 is a diagram showing an example of an association information DB;

FIG. 7 is a sequence diagram showing an example of the operation of the contract management system;

FIG. 8 is a sequence diagram showing an example of the operation of the contract management system;

FIG. 9 is a flowchart showing the procedure of a smart-contract recording process in the contract management system; and

FIG. 10 is a flowchart showing the procedure of a contract execution process in the contract management system.

### DETAILED DESCRIPTION OF THE PREFERRED EMBODIMENTS

Hereinafter, an embodiment of the present invention will be described with reference to the drawings.

[1. Configuration and Mode of Use of Contract Management System]

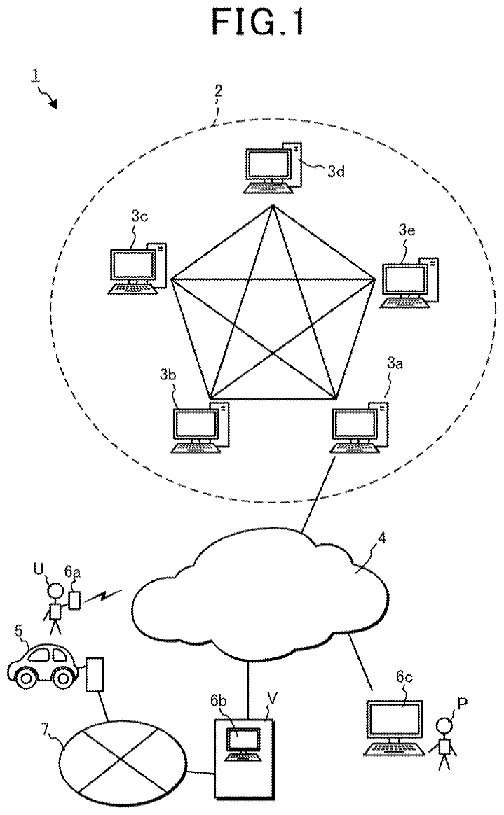

FIG. 1 is a diagram illustrating the configuration of a contract management system according to an embodiment of the present invention. The contract management system 1 illustrated in FIG. 1 manages, as an example, smart contracts related to contracts on electric power transaction using the battery of a vehicle 5 between the user U of the vehicle 5, which is an electric vehicle, and an electric power company V. This contract includes, as the contract conditions, the electric-power purchase unit price at the time when the user U charges the vehicle 5 from an electric power network 7 of the electric power company V and the electric-power sales unit price at the time when the user U discharges the vehicle 5 to the electric power network 7.

The contract management system 1 includes five node computers 3a, 3b, 3c, 3d, and 3e serving as nodes of a blockchain network 2. Hereinafter, the node computers 3a, 3b, 3c, 3d, and 3e are collectively referred to as node computers 3. Note that the number of node computers 3 included in the contract management system 1 is not limited to five but can be any number larger than or equal to two. The node computers 3 are communicably connected to one another and operate such that each node computer holds the same distributed ledger, to compose a private or public blockchain network 2 based on, for example, an Ethereum platform.

The contract management system 1 also includes a plurality of terminal apparatuses communicably connected to at least one of the node computers 3, for example, the node computer 3a, via a communication network 4. In the example illustrated in FIG. 1, the contract management system 1 includes, as the terminal apparatuses, a first contracting-party terminal 6a operated by the user U of the vehicle 5 who is one contracting party of the foregoing electric-power transaction contract, a second contracting-party terminal 6b operated by the electric power company V which is the other contracting party, and an operator terminal 6c operated by an operator P. Here, the operator P is an operator certified for managing smart contracts.

The first contracting-party terminal 6a is, for example, a mobile terminal owned by the user U of the vehicle 5. The first contracting-party terminal 6a corresponds to a terminal apparatus seeking to execute a contract in the present disclosure. Hereinafter, the first contracting-party terminal 6a, the second contracting-party terminal 6b, and the operator terminal 6c are collectively referred to as terminal apparatuses 6.

The contract management system 1 manages generation, change, and execution of the electric-power transaction contract by recording them in the distributed ledgers. The electric-power transaction contract is, for example, generated by the electric power company V. This electric-power transaction contract is deemed to be concluded between the electric power company V and the user U when execution of charging or discharging between the vehicle 5 and the electric power network 7 is started. This electric-power transaction contract is executed as transfer of a fee for the above charging or discharging. Note that the user U can be an unspecific person who uses any vehicle 5 that can be charged from or discharged to the electric power network 7.

Specifically, the electric power company V records a smart contract for an electric-power transaction contract in a blockchain by using the node computer 3a. The user U, when completing charging or discharging of the vehicle 5 from or to the electric power network 7, executes the above smart contract to execute the above electric-power transaction contract to transfer a fee for the above charging or discharging. As described above, the electric-power transaction contract can include, as the contract conditions, the electric-power purchase unit price at the time of charging the vehicle 5 from the electric power network 7 and the electric-power sales unit price at the time of discharging the vehicle 5 to the electric power network 7. The electric power company V modifies or revises the above electric-power transaction contract by changing the above contract conditions: the electric-power purchase unit price or the electric-power sales unit price, according to the situation of the electric power market.

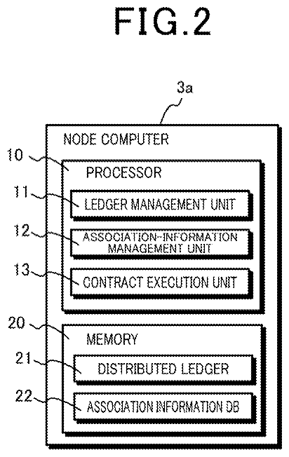

FIG. 2 is a diagram illustrating an example of the configuration of the node computer 3a. The node computer 3a includes a processor 10 and a memory 20. The memory 20 includes, for example, volatile and/or nonvolatile semiconductor memories and/or a hard disk apparatus. The processor 10 includes, for example, one or a plurality of central processing units (CPUs) or micro processing units (MPUs).

The processor 10 includes a ledger management unit 11, an association-information management unit 12, and a contract execution unit 13, as functional elements or functional units. These functional elements included in the processor 10 are implemented, for example, by the processor 10 executing a computer program stored in the memory 20.

The ledger management unit 11 receives transaction data and records a block including the received transaction data in a distributed ledger 21 stored in the memory 20. Specifically, the ledger management unit 11 receives transaction data from another node computer 3, a terminal apparatus 6, or the association-information management unit 12 described later and generates a block including the received transaction data. Then, the ledger management unit 11 records the generated block in the distributed ledger 21 stored in the memory 20 and also transmits the generated block to the other node computers 3. With this operation, also in the other node computers 3, the above generated block is recorded in the distributed ledger held by each node computer 3.

After the ledger management unit 11 receives transaction data including a smart contract including a program to process execution of the electric-power transaction contract generated by the electric power company V, for example, from the operator terminal 6c, the ledger management unit 11 records a block including the received transaction data in the distributed ledger 21.

Note that foregoing generation of the block and recording of the generated block in the distributed ledger 21 by the ledger management unit 11 are executed by using conventional techniques in accordance with the rules of the blockchain platform such as Ethereum. Such rules can include a process of verifying the validity of the digital signature of the author included in transaction data, a mining process that can be performed when generating a block, and/or execution of a consensus algorithm.

When the ledger management unit 11 records the block including the transaction data including the smart contract on a contract in the distributed ledger 21, the association-information management unit 12 generates association information that associates the contract address, where the smart contract is stored, with the contract identification information for identifying the above contract and manages the generated association information by storing it into a specific storing place.

In the present embodiment, the ledger management unit 11 receives transaction data including the smart contract including a program to process execution of the electric-power transaction contract from the second contracting-party terminal 6b of the electric power company V and records a block including the received transaction data in the distributed ledger 21. In response to this operation, the association-information management unit 12 generates association information that associates the contract address, where the above smart contract is stored, with the contract identification information on the above electric-power transaction contract and manages the generated association information by storing it in a specific storing place, for example, in the association information database (association information DB) 22 of the memory 20. The above contract identification information is the contract identification name, in other words, the name of the above contract in the present embodiment. The contract identification name can be a contract name included in the smart contract in the transaction data received from the operator terminal 6c.

The association-information management unit 12 includes a unique identification ID for identifying each individual piece of association information and a flag indicating whether the piece of association information is valid or invalid, in each piece of association information and stores it in the association information DB22. The association-information management unit 12 transmits the identification ID of the generated association information to the operator terminal 6c, and the operator terminal 6c transmits the identification ID to the second contracting-party terminal 6b of the electric power company V.

When the association-information management unit 12 receives an instruction to delete association information from the operator terminal 6c, the association-information management unit 12 deletes the association information specified by the deletion instruction from the association information DB22. When the association-information management unit 12 receives an instruction to invalidate association information from the operator terminal 6c, the association-information management unit 12 invalidates the association information specified by the invalidation instruction. Further, when the association-information management unit 12 receives an instruction to validate association information from the operator terminal 6c, the association-information management unit 12 validates the association information specified by the validation instruction.

Here, each of the above deletion instruction, invalidation instruction, and validation instruction may include the identification ID of the association information to be deleted, invalidated, or validated. The above invalidation may be performed by resetting the flag included in the corresponding association information to “0”, and the above validation may be performed by setting the above flag to “1”.

After the association-information management unit 12 generates, deletes, invalidates, or validates association information as above, the association-information management unit 12 generates transaction data on the generation, deletion, invalidation, or validation of the association information and sends it to the ledger management unit 11. The ledger management unit 11 records a block including the above generated transaction data in the distributed ledger 21. The above transaction data may include a digital signature indicating the node computer 3a that performed the above generation, deletion, invalidation, or validation of association information.

Further, the association-information management unit 12 transmits the contract address of a valid smart contract to be used for execution of the electric-power transaction contract to the first contracting-party terminal 6a of the user U seeking to execute the electric-power transaction contract, based on the association information stored in the association information DB22. For example, when the association-information management unit 12 receives an address request (described later) that the first contracting-party terminal 6a transmits when executing the electric-power transaction contract, the association-information management unit 12 refers to the association information DB22 and returns the contract address indicated by valid association information including the contract identification name specified by the address request to the first contracting-party terminal 6a. Here, valid association information means, for example, association information having a foregoing flag of “1”.

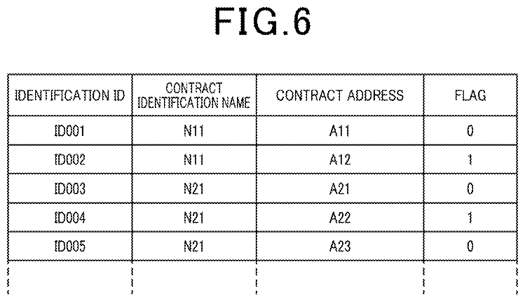

FIG. 6 is a diagram showing an example of the association information DB22 that the association-information management unit 12 of the node computer 3a stores in the memory 20. The association information DB22 shown in FIG. 6 is in the form of a table in which each line excluding the uppermost line indicates one piece of association information.

The leftmost first row of the lines shows identifications ID, the second row shows contract identification names, the third row shows contract addresses, and the fourth row shows flags. The flag “0” indicates that the association information in the line is invalid, and the flag “1” indicates that the association information in the line is valid.

In the example of FIG. 6, the first and second lines excluding the uppermost title line show the contract addresses A11 and A12 of two smart contracts on contracts having the contract identification name N11. Since the flag of the second line is “1”, in other words, valid, it shows that the contract address A12 is the valid, in other words, latest contract address of the smart contract at present on the contract having the contract identification name N11.

Similarly, regarding the contract having the contract identification name N21, since the flag of the fourth line is “1”, it shows that the contract address A22 is the valid contract address of the smart contract at present on the contract having the contract identification name N21.

With reference to FIG. 2, the contract execution unit 13, when receiving transaction data transmitted to a contract address from one of the terminal apparatuses 6, executes the program included in the smart contract stored at the contract address. Thus, the contract according to the smart contract is executed.

In the present embodiment, for example, the first contracting-party terminal 6a seeking to execute the electric-power transaction contract transmits transaction data instructing execution of the electric-power transaction contract to the contract address that the association-information management unit 12 transmitted in response to the foregoing address request. This transaction data may include information on discrimination of charging/discharging between the vehicle 5 and the electric power network 7 and information on the amount of charge or the amount of discharge, as execution conditions for executing the electric-power transaction contract.

The contract execution unit 13, in response to the reception of the above transaction data, executes the program included in the smart contract stored in the contract address that is the transmission destination of the transaction data, using the above execution conditions included in the transaction data. With this operation, the electric-power transaction contract is executed based on the above execution conditions, and money is transferred according to the amount of charge or the amount of discharge between the vehicle 5 and the electric power network 7.

In this process, the ledger management unit 11 records a block including the above received transaction data in the distributed ledger 21 by using conventional techniques. With this process, the execution of the above electric-power transaction contract is recorded in the blockchain formed in the distributed ledgers.

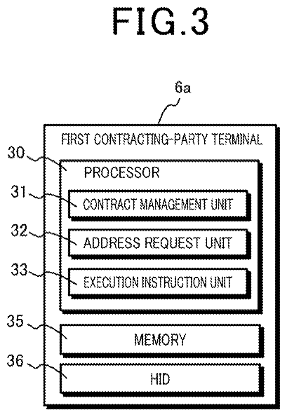

Next the configuration of the first contracting-party terminal 6a will be described. FIG. 3 is a diagram illustrating an example of the configuration of the first contracting-party terminal 6a operated by the user U who is one contracting party of the electric-power transaction contract. The first contracting-party terminal 6a is, for example, a mobile terminal owned by the user U. The first contracting-party terminal 6a includes a processor 30, a memory 35, and a human interface device (HID) 36. The HID 36, which is, for example, a touch panel, presents the user U with information and obtains data and instructions inputted from the user U. The memory 35 includes, for example, volatile and/or nonvolatile semiconductor memories. The processor 30 is, for example, a CPU.

The processor 30 includes a contract management unit 31, an address request unit 32, and an execution instruction unit 33, as functional elements or functional units. These functional elements included in the processor 30 are implemented, for example, by the processor 30 executing a computer program stored in the memory 35.

The contract management unit 31, according to an instruction from the user U obtained through the HID 36, obtains the contract identification information on the electric-power transaction contract from the second contracting-party terminal 6b of the electric power company V that provides an electric power transaction that the user U intends to use. The contract management unit 31 stores the contract information that associates the identification information (for example, name) of the electric power company V with the above obtained contract identification information into the memory 35. As described above, in the present embodiment, the contract identification information is the contract identification name.

When the user U needs to execute the contract, the user U inputs a contract execution instruction through the HID 36. It is assumed that the contract execution instruction that the user U inputs includes, for example, the name of the electric power company V and execution conditions used for executing the contract. The execution conditions may include, for example, information on discrimination of charging/discharging between the vehicle 5 and the electric power network 7 and information on the amount of charge or the amount of discharge.

The address request unit 32, in response to the input of the contract execution instruction from the user U, transmits the contract identification information on the electric-power transaction contract that the user U is seeking to execute and an address request together to the node computer 3a. Specifically, the address request unit 32 refers to the contract information stored in the memory 35 and obtains the contract identification information associated with the name of the electric power company V included in the above contract execution instruction. The address request unit 32 transmits the address request including designation of the above obtained contract identification information to the node computer 3a. Then, the address request unit 32 receives a contract address returned from the node computer 3a (specifically, from the association-information management unit 12 of the node computer 3a) and passes the received contract address to the execution instruction unit 33.

The execution instruction unit 33, in response to the input of the above contract execution instruction from the user U, generates transaction data for executing the contract. For example, in the case of a Ethereum platform, the transaction data may include the externally owned account (EOA) of the electronic wallet that the user U uses for transferring fees, the execution conditions included in the contract execution instruction inputted by the user U, the contract identification information on the electric-power transaction contract to be executed, and a digital signature indicating the user U.

The execution instruction unit 33 uses the above contract address returned from the node computer 3a, obtained via the address request unit 32 to transmit the above generated transaction data to the contract address.

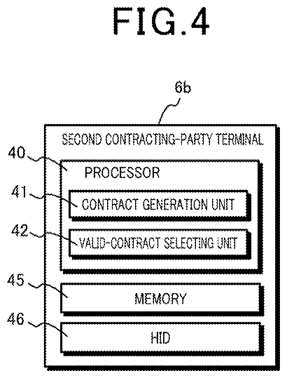

Next, the configuration of the second contracting-party terminal 6b will be described. FIG. 4 is a diagram illustrating an example of the configuration of the second contracting-party terminal 6b operated by the electric power company V which is the other contracting party of the electric-power transaction contract. The second contracting-party terminal 6b includes a processor 40, a memory 45, and an HID 46. The HID 46 is, for example, a touch panel. The memory 45 includes, for example, volatile and/or nonvolatile semiconductor memories. The processor 40 is, for example, a CPU.

The processor 40 includes a contract generation unit 41 and a valid-contract selecting unit 42 as functional elements or functional units. These functional elements included in the processor 40 are implemented, for example, by the processor 40 executing a computer program stored in the memory 45.

The contract generation unit 41, in response to input of a contract generation instruction via the HID 46 by a person in charge of the contract in the electric power company V, generates or modifies an electric-power transaction contract and generates a smart contract including a program used for executing the generated or modified electric-power transaction contract. This smart contract may include contract identification information on the electric-power transaction contract and identification information on the smart contract. The contract generation unit 41 generates transaction data including the above generated smart contract and a digital signature indicating the electric power company V and transmits it to the operator terminal 6c.

After that, the contract generation unit 41 receives the identification ID of the association information that associates the contract address of the above smart contract with the contract identification information, from the node computer 3a that recorded the above transaction data in the blockchain via the operator terminal 6c. The contract generation unit 41 stores the contract information that associates the identification information on the smart contract with the above received identification ID into the memory 45.

The valid-contract selecting unit 42, in response to input of an instruction to delete, validate, or invalidate association information from a person in charge of the contract in the electric power company V via the HID 46, transmits an instruction to delete, an instruction to validate, or an instruction to invalidate the association information to the operator terminal 6c. The above deletion instruction, the validation instruction, and the invalidation instruction may include the identification ID of the target information to be deleted, validated, or invalidated, information indicating which operation to be performed, deletion, validation, or invalidation, and a digital signature of the electric power company V. The person in charge of the contract in the electric power company V, when inputting an instruction to delete, validate, or invalidate association information, can select the identification ID of the association information on the smart contract to be deleted, validated, or invalidated from the contract information stored in the memory 45 and input the selected identification ID into the HID 46.

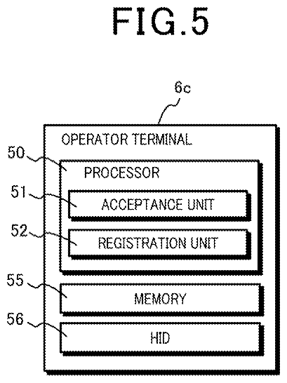

Next, the configuration of the operator terminal 6c will be described. FIG. 5 is a diagram illustrating an example of the configuration of the operator terminal 6c. The operator terminal 6c includes a processor 50, a memory 55, and an HID 56. The HID 56 is, for example, a touch panel. The memory 55 includes, for example, volatile and/or nonvolatile semiconductor memories. The processor 50 is, for example, a CPU.

The processor 50 includes an acceptance unit 51 and a registration unit 52 as functional elements or functional units. These functional elements included in the processor 50 are implemented, for example, by the processor 50 executing a computer program stored in the memory 55.

The acceptance unit 51 receives consignment concerning management of smart contracts from a terminal apparatus 6 of a contracting party. Specifically, the acceptance unit 51 receives transaction data including a smart contract concerning an electric-power transaction contract from the second contracting-party terminal 6b of the electric power company V. Then, the acceptance unit 51 uses conventional techniques to verify the validity of the digital signature included in the received transaction and, if it is valid, passes the transaction data to the registration unit 52.

The acceptance unit 51 receives an instruction to delete, an instruction to validate, and an instruction to invalidate association information from the second contracting-party terminal 6b of the electric power company V. The acceptance unit 51 verifies the validity of the digital signature included in the deletion instruction, the validation instruction, and the invalidation instruction and, if it is valid, pass those instructions to the registration unit 52.

The registration unit 52 transmits the transaction data including the smart contract passed from the acceptance unit 51, to the node computer 3a. The registration unit 52 receives the identification ID of the association information on the above smart contract from the association-information management unit 12 of the node computer 3a and transmits it to the second contracting-party terminal 6b of the electric power company V.

The registration unit 52, in response to the reception of the instruction to delete, instruction to validate, or instruction to invalidate association information from the acceptance unit 51, transmits the received deletion instruction, validation instruction, or invalidation instruction to the node computer 3a.

In the contract management system 1 having the above configuration, at least one of the node computers 3a generates and stores association information that associates the contract address where the smart contract to be used for executing a contract (for example, an electric-power transaction contract) is stored, with the contract identification information (for example, the contract identification name) for identifying the contract.

Hence, in the contract management system 1, the first contracting-party terminal 6a of the user U seeking to execute the contract can obtain the contract address of the valid (for example, the latest) smart contract at present to be used for executing the contract, from the node computer 3a that stores the above association information. Thus, in the contract management system 1, when a contract condition is changed, the user U himself/herself does not need to inquire the contract address of a valid smart contract at present from the electric power company V or the like or manually input the contract address of the valid smart contract into the first contracting-party terminal 6a.

With this configuration, in the contract management system 1, even in the case in which the contract conditions can often change, it is possible to prevent increase in the number of manual operations on the first contracting-party terminal 6a of the user U who executes the contract and improve convenience in contract execution using a smart contract.

[2. Operation Example of Contract Management System]

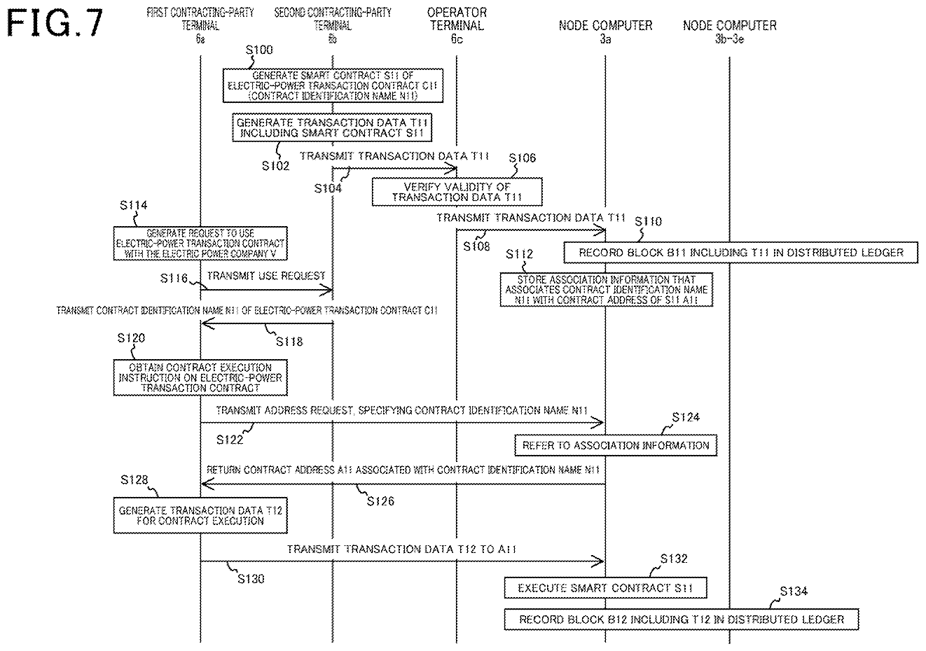

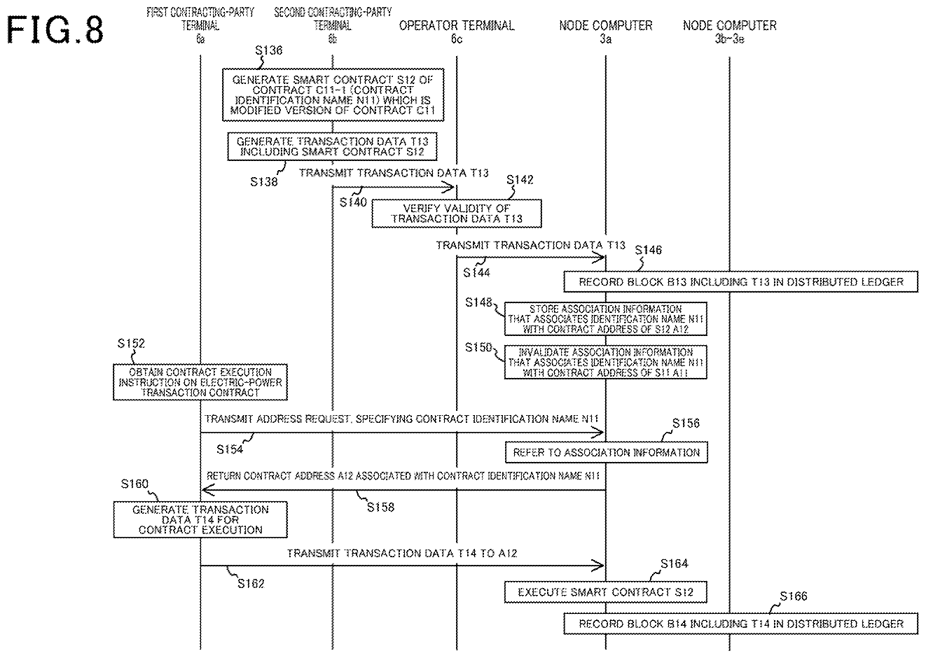

FIGS. 7 and 8 are sequence diagrams showing an example of the operation of the contract management system 1. The sequence diagram of FIG. 7 will be briefly explained. First, the second contracting-party terminal 6b of the electric power company V generates transaction data T11 including a smart contract S11 of an electric-power transaction contract C11 and transmits the generated transaction data T11 to the node computer 3a via the operator terminal 6c. With this operation, the above smart contract S11 is recorded in a blockchain. The first contracting-party terminal 6a of the user U executes the smart contract S11. The contract conditions of the above electric-power transaction contract C11 include the electric-power purchase unit price and the electric-power sales unit price.

FIG. 8 is an example of operation after the operation shown in FIG. 7. The sequence diagram of FIG. 8 will be briefly explained. The second contracting-party terminal 6b of the electric power company V generates an electric-power transaction contract C11-1 with a modified contract condition of the electric-power transaction contract C11 and generates transaction data T13 including a smart contract S12 of the electric-power transaction contract C11-1. The second contracting-party terminal 6b transmits the generated transaction data T13 to the node computer 3a via the operator terminal 6c. Thus, the above smart contract S12 is recorded in the blockchain. The first contracting-party terminal 6a of the user U executes the smart contract S12.

Hereinafter, each step in the sequence diagrams shown in FIGS. 7 and 8 will be explained.

With reference to FIG. 7, first, the second contracting-party terminal 6b of the electric power company V generates a smart contract S11 of an electric-power transaction contract C11 (S100) and also generates transaction data T11 including the smart contract S11 (S102). Here, it is assumed that the contract identification name of the electric-power transaction contract C11 which is the contract identification information is N11. The operations in steps S100 and S102 are performed by the contract generation unit 41 of the second contracting-party terminal 6b.

Next, the contract generation unit 41 of the second contracting-party terminal 6b transmits the above generated transaction data T11 to the operator terminal 6c (S104). The acceptance unit 51 of the operator terminal 6c receives this transaction data T11 and verifies the validity (S106). If the transaction data T11 is valid, the registration unit 52 of the operator terminal 6c transmits the transaction data T11 to the node computer 3a (S108).

The ledger management unit 11 of the node computer 3a, in response to the reception of the transaction data T11 including the smart contract S11, uses conventional techniques to generate a block B11 including the received transaction data T11 and transmits it to the other node computers 3. Then, for example, each node computer 3 executes a consensus algorithm on the block B11, and if the result does not have a problem, the block B11 is recorded in the distributed ledgers of all the node computers 3 including the distributed ledger 21 of the node computer 3a (S110). With this, the smart contract S11 becomes executable.

Next, the association-information management unit 12 of the node computer 3a stores association information that associates the contract identification name N11 of the electric-power transaction contract C11 of the above smart contract S11 with the contract address A11 where the smart contract S11 is stored, into the association information DB22 (S112). In this process, the association-information management unit 12 generates transaction data on the generation of the above association information and transmits it to the ledger management unit 11, and the ledger management unit 11, as in step 110, records the block including the transaction data on the generation of the above association information in the distributed ledgers of all the node computers 3 including the distributed ledger 21 of the node computer 3a.

Meanwhile, the user U who desires electric power transaction between the electric power network 7 of the electric power company V and the vehicle 5 gives an instruction to the first contracting-party terminal 6a to generate a request to use an electric-power transaction contract with the electric power company V (S114) and transmits the generated use request to the second contracting-party terminal 6b of the electric power company V (S116). The generation and transmission of this use request are executed by the contract management unit 31 of the first contracting-party terminal 6a.

The second contracting-party terminal 6b, in response to the reception of the use request from the first contracting-party terminal 6a, transmits the contract identification name N11 of the electric-power transaction contract C11 to the first contracting-party terminal 6a (S118). The contract management unit 31 of the first contracting-party terminal 6a stores the contract information that associates the identification information on the electric power company V (for example, the name of the electric power company V) with the above received contract identification name N11, in the memory 35.

After that, the user U performs charging or discharging of the vehicle 5 from or to the electric power network 7 of the electric power company V and then inputs a contract execution instruction of the electric-power transaction contract with the electric power company V into the first contracting-party terminal 6a, and the first contracting-party terminal 6a obtains the contract execution instruction (S120). In response to the obtaining of the contract execution instruction, the address request unit 32 of the first contracting-party terminal 6a refers to the stored contract information, based on the identification information on the electric power company V included in the contract execution instruction and obtains the contract identification name N11 of the electric-power transaction contract of the electric power company V. The address request unit 32 of the first contracting-party terminal 6a transmits an address request for the contract address of the smart contract to the node computer 3a, specifying the above obtained contract identification name N11 (S122).

The association-information management unit 12 of the node computer 3a, in response to the reception of the address request from the first contracting-party terminal 6a, refers to the association information stored in the association information DB22 (S124) and obtains the contract address A11 of the smart contract S11 associated with the contract identification name N11 from the association information associated with the above specified contract identification name N11, out of the valid association information (in other words, having a flag of “1”). Then, the association-information management unit 12 of the node computer 3a transmits the above obtained contract address A11 to the first contracting-party terminal 6a (S126).

The execution instruction unit 33 of the first contracting-party terminal 6a generates transaction data T12 for executing the electric-power transaction contract (S128) and transmits the generated transaction data T12 to the contract address A11 transmitted from the node computer 3a in step S126 (S130). In the node computer 3a having received this transaction data T12, the contract execution unit 13 executes the smart contract S11 stored at the contract address A11 which is the transmission destination of the transaction data T12 (S132). With this operation, the electric-power transaction contract C11 is executed, and payment of a charging fee or a discharging fee is made between the user U and the electric power company V.

Next, the ledger management unit 11 of the node computer 3a generates a block B12 including the received transaction data T12 and transmits it to the other node computers 3. With this operation, as in step S110, the block B12 is recorded in the distributed ledgers of all the node computers 3 including the distributed ledger 21 of the node computer 3a (S134).

With reference to FIG. 8, after that, the electric power company V, following the situation of the electric power market, changes the electric-power purchase unit price and/or the electric-power sales unit price, modifies the contract conditions of the electric-power transaction contract C11, and generates the electric-power transaction contract C11-1. Here, it is assumed that the contract identification name of the electric-power transaction contract C11-1 is N11 which is the same as the contract identification name of the electric-power transaction contract C11.

The contract generation unit 41 of the second contracting-party terminal 6b of the electric power company V, following an instruction from the person in charge of the contract in the electric power company V via the HID 46, generates the smart contract S12 of the electric-power transaction contract C11-1 (S136) and also generates transaction data T13 including the smart contract S12 (S138).

Then, the contract generation unit 41 of the second contracting-party terminal 6b transmits the above generated transaction data T13 to the operator terminal 6c (S140). The acceptance unit 51 of the operator terminal 6c receives this transaction data T13 and verifies the validity (S142). If the transaction data T13 is valid, the registration unit 52 of the operator terminal 6c transmits the transaction data T13 to the node computer 3a (S144).

The ledger management unit 11 of the node computer 3a, in response to the reception of the transaction data T13 including the smart contract S12, uses conventional techniques to generate a block B13 including the received transaction data T13 and transmits it to the other node computers 3. With this operation, as in step S110, the block B13 is recorded in the distributed ledgers of all the node computers 3 including the distributed ledger 21 of the node computer 3a (S146). With this, the smart contract S12 becomes executable.

Next, the association-information management unit 12 of the node computer 3a stores association information that associates the contract identification name N11 of the electric-power transaction contract C11-1 of the above smart contract S12 with the contract address A12 where the smart contract S12 is stored, into the association information DB22 (S148). The association-information management unit 12 resets the flag of the association information on the contract identification name N11 stored in the association information DB22 in the past, in other words, the flag of the association information stored in step S112 in FIGS. 7, to “0” to invalidate this association information (S150).

Following the execution of the above processes in step S148 and step S150, the association-information management unit 12 generates transaction data on the generation of the association information in step S148 and transaction data on the invalidation of the above association information in step S150 and transmits them to the ledger management unit 11. The ledger management unit 11, as in step 110, records a block including the transaction data on the generation and the transaction data on the invalidation of the above association information, in the distributed ledgers of all the node computers 3 including the distributed ledger 21 of the node computer 3a.

After that, the user U again performs charging or discharging of the vehicle 5 from or to the electric power network 7 of the electric power company V and then inputs a contract execution instruction of the electric-power transaction contract with the electric power company V into the first contracting-party terminal 6a, and the first contracting-party terminal 6a obtains the contract execution instruction (S152). In response to the obtaining of the contract execution instruction, the address request unit 32 of the first contracting-party terminal 6a refers to the stored contract information based on the identification information on the electric power company V included in the contract execution instruction and obtains the contract identification name N11 of the electric-power transaction contract of the electric power company V. The address request unit 32 of the first contracting-party terminal 6a transmits an address request for the contract address of the smart contract to the node computer 3a, specifying the above obtained contract identification name N11 (S154).

The association-information management unit 12 of the node computer 3a, in response to the reception of the address request from the first contracting-party terminal 6a, refers to the association information stored in the association information DB22 (S156) and obtains the contract address A12 of the smart contract S12 associated with the contract identification name N11 from the association information associated with the above specified contract identification name N11, out of the valid association information (in other words, having a flag of “1”). Then, the association-information management unit 12 of the node computer 3a transmits the above obtained contract address A12 to the first contracting-party terminal 6a (S158).

The execution instruction unit 33 of the first contracting-party terminal 6a generates transaction data T14 for executing the electric-power transaction contract (S160) and transmits the generated transaction data T14 to the contract address A12 transmitted from the node computer 3a in step S158 (S162). In the node computer 3a having received this transaction data T14, the contract execution unit 13 executes the smart contract S12 stored at the contract address A12 which is the transmission destination of the transaction data T14 (S164). With this operation, the latest modified electric-power transaction contract C11-1 is executed, and payment of a charging fee or a discharging fee is made between the user U and the electric power company V.

Next, the ledger management unit 11 of the node computer 3a generates a block B14 including the received transaction data T14 and transmits it to the other node computers 3. With this operation, as in step S110, the block B14 is recorded in the distributed ledgers of all the node computers 3 including the distributed ledger 21 of the node computer 3a (S166).

[3. Operation Procedure of Contract Management System]

Next, the operation procedure of the contract management system 1 will be described.

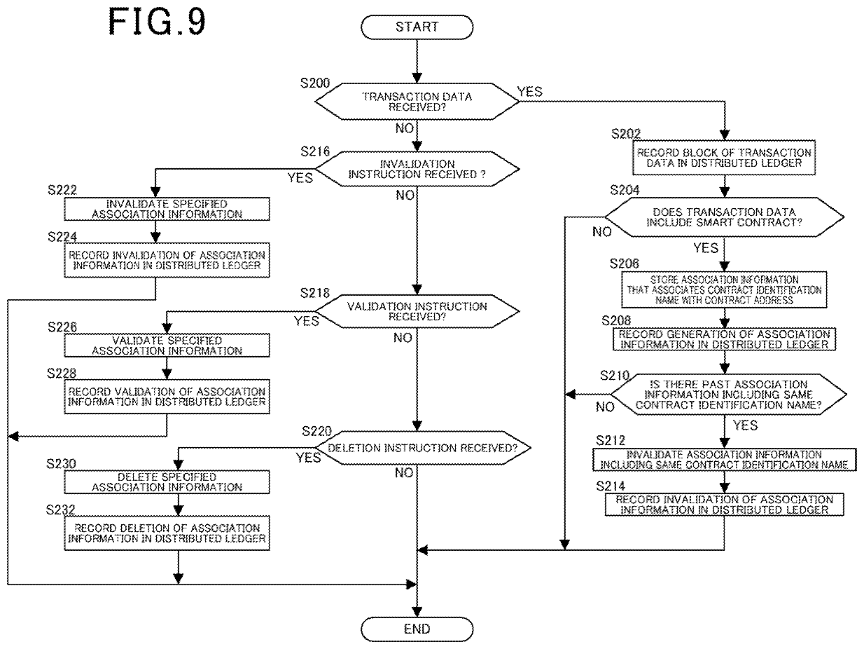

First, with reference to a flowchart shown in FIG. 9, the procedure of the smart-contract recording process performed by the node computer 3a of the contract management system 1 will be described. The smart-contract recording process is a process of recording a block of transaction data including a smart contract in the distributed ledger 21. The process shown in FIG. 9 is executed repeatedly.

When the process starts, first, the ledger management unit 11 determines whether it has received transaction data from the terminal apparatus 6 (S200). If the ledger management unit 11 has received transaction data (S200, YES), the ledger management unit 11 generates a block including the transaction data and stores the generated block in the distributed ledger 21 (S202).

Next, the ledger management unit 11 determines whether the received transaction data includes a smart contract (S204). For example, the ledger management unit 11 uses the public key of the digital signature included in the received transaction data to decode the transaction data, and the ledger management unit 11 can determine whether the transaction data includes a smart contract.

If the received transaction data includes a smart contract (S204, YES), the association-information management unit 12 stores association information that associates the contract identification name included in the smart contract with the contract address indicating where the smart contract is stored, in the association information DB22 in the memory 20 (S206). The association-information management unit 12 generates transaction data indicating the generation of the above association information, and the ledger management unit 11 records a block including the above generated transaction data in the distributed ledger 21 (S208).

Next, the association-information management unit 12 determines whether there is valid association information stored in the past, including the same contract identification name as the contract identification name included in the association information stored in step S206 (S210). If there is valid association information stored in the past, including the same contract identification name (S210, YES), the association-information management unit 12 invalidates the past association information including the same contract identification name (S212). This invalidation can be made by resetting the flag attached to the past association information to “0”. Next, the association-information management unit 12 generates transaction data indicating the invalidation of the above association information, and the ledger management unit 11 records a block including the above generated transaction data in the distributed ledger 21 (S214). After that, the ledger management unit 11 ends this process.

In step S204, if the received transaction data does not include the smart contract (S204, NO), or if there is no past valid association information including the same contract identification name in step S210 (S210, NO), the ledger management unit 11 ends the process without doing anything.

In step S200, if the ledger management unit 11 has not received transaction data (S200, NO), the association-information management unit 12 determines whether it has received an instruction to invalidate association information (S216). Then, if the association-information management unit 12 has received an invalidation instruction (S216, YES), the association-information management unit 12 invalidates the association information having the identification ID specified by the received invalidation instruction (S222). The association-information management unit 12 generates transaction data indicating the above invalidation of the association information, and the ledger management unit 11 records a block including the above generated transaction data in the distributed ledger 21 (S224). After that, the ledger management unit 11 ends this process.

In step S216, if the association-information management unit 12 has not received an instruction to invalidate association information (S216, NO), the association-information management unit 12 determines whether it has received an instruction to validate association information (S218). Then, if the association-information management unit 12 has receives a validation instruction (S218, YES), the association-information management unit 12 validates the association information having the identification ID specified by the received validation instruction (S226). This validation can be made by setting the flag attached to the past association information to “1”.

The association-information management unit 12 generates transaction data indicating the above validation of the association information, and the ledger management unit 11 records a block including the above generated transaction data in the distributed ledger 21 (S228). After that, the ledger management unit 11 ends this process.

If the association-information management unit 12 has not received an instruction to validate association information in step S218 (S218, NO), the association-information management unit 12 determines whether it has received an instruction to delete association information (S220). Then, if the association-information management unit 12 has received a deletion instruction (S220, YES), the association-information management unit 12 deletes the association information having the identification ID specified by the received deletion instruction from the association information DB22 (S230).

The association-information management unit 12 generates transaction data indicating the above deletion of the association information, and the ledger management unit 11 records a block including the above generated transaction data in the distributed ledger 21 (S232). After that, the ledger management unit 11 ends this process.

If the association-information management unit 12 has not received an instruction to delete association information in step S220 (S220, NO), the ledger management unit 11 ends this process.

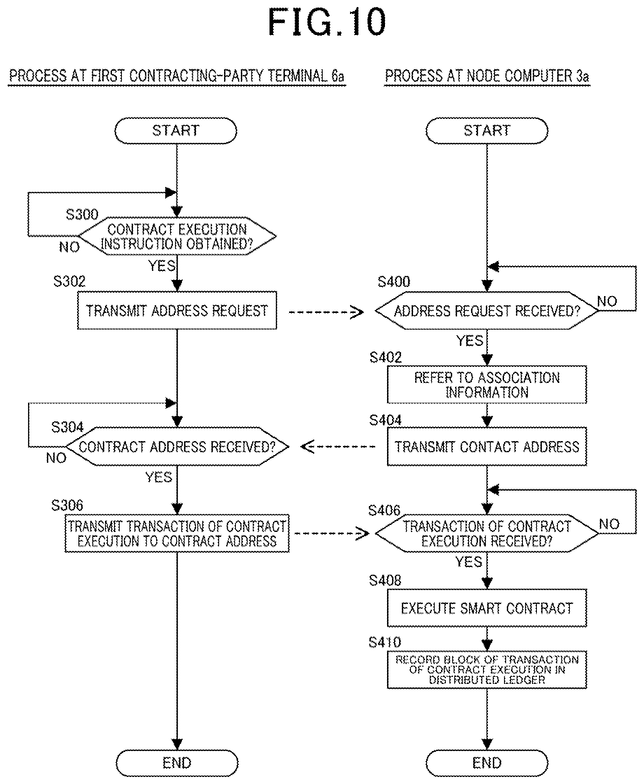

FIG. 10 is a flowchart showing the procedure of a contract execution process of the contract management system 1. The contract execution process is a process of executing a contract by executing a smart contract recorded in the distributed ledger of the blockchain, based on an instruction of the first contracting-party terminal 6a. In FIG. 10, the flowchart at the left part of the figure shows the procedure of the process in the first contracting-party terminal 6a, and the flowchart at the right part of the figure shows the procedure of the process in the node computer 3a. These processes are repeatedly executed. Note that the dotted line arrows between the right and left flowcharts in the figure show transmission and reception of information between the first contracting-party terminal 6a and the node computer 3a.

When the first contracting-party terminal 6a starts the process, the address request unit 32 determines whether it has obtained a contract execution instruction by input from the user U (S300). If the address request unit 32 has not obtained a contract execution instruction (S300, NO), the address request unit 32 returns to step S300 and repeats the process to keep waiting to obtain a contract execution instruction.

The association-information management unit 12 of the node computer 3a, when starting the process, determines whether it has received an address request from the first contracting-party terminal 6a (S400). If the association-information management unit 12 has not received an address request (S400, NO), it returns to step S400 and repeats the process to keep waiting to receive an address request.

Later, when the first contracting-party terminal 6a obtains a contract execution instruction (S300, YES), the address request unit 32 refers to the contract information stored in the memory 35 and obtains the contract identification name associated with the identification information on the other party of the contract to be executed (in the present embodiment, the name of the electric power company V which is the other party of the electric-power transaction contract). The address request unit 32 transmits an address request including designation of the obtained contract identification name to the node computer 3a (S302).

Next, the address request unit 32 determines whether it has received a contract address from the node computer 3a (S304). Then, if the address request unit 32 has not received a contract address (S304, NO), the address request unit 32 returns to step S304 and repeats the process to keep waiting to receive a contract address.

When the association-information management unit 12 of the node computer 3a receives the address request transmitted by the first contracting-party terminal 6a in step S302 (S400, YES), the association-information management unit 12 refers to the association information stored in the association information DB22 in the memory 20 (S402) and obtains the contract address from the valid association information including the contract identification name specified by the above received address request. The association-information management unit 12 transmits the obtained contract address to the first contracting-party terminal 6a (S404).

Next, the node computer 3a determines whether the node computer 3a has received a transaction of contract execution transmitted from the first contracting-party terminal 6a to the above contract address (S406). Then, if the node computer 3a has not received a transaction of contract execution, the node computer 3a returns to step S406 and repeats the process to keep waiting to receive a transaction of contract execution.

When the first contracting-party terminal 6a receives the contract address transmitted by the node computer 3a in step S404 (S304, YES), the execution instruction unit 33 generates a transaction of contract execution, transmits the generated transaction of contract execution to the above received contract address (S306), and ends the process.

When the node computer 3a receives the transaction of contract execution transmitted by the first contracting-party terminal 6a in step S306 (S406, YES), the contract execution unit 13 executes the contract by executing the program included in the smart contract stored at the contract address which is the transmission destination of the above transaction of contract execution (S408).

Next, the ledger management unit 11 of the node computer 3a records a block including the above received transaction of contract execution in the distributed ledger 21 (S410) and ends the process.

### 4. Other Embodiments

In the above embodiment, the first contracting-party terminal 6a of the user U which executes an electric-power transaction contract with the electric power company V via the vehicle 5 is a mobile terminal owned by the user U of the vehicle 5, but it may be a terminal apparatus mounted on the vehicle 5. In this case, the in-vehicle terminal apparatus can obtain the amount of charge and the amount of discharge in the vehicle 5, which is an execution condition of the electric-power transaction contract, directly via the in-vehicle apparatus, and this further reduces the number of manual operations by the user U on the above terminal apparatus, further improving the convenience.

The contracts that the contract management system 1 deals with are not limited to electric-power transaction contracts involving payment and receipt of money in contract execution, as shown in the above embodiment as an example. The contracts that the contract management system 1 deals with may be any contracts the executional actions of which can be described as programs. For example, the contracts that the contract management system 1 deals with may be contracts involving paying fees for the amount of gas use or the amount of water use measured by gas meters or water meters. The contracts that the contract management system 1 deals with may be contracts not involving payment and receipt of money.

Although in the above embodiment, the association-information management unit 12 is included in the node computer 3a, the association-information management unit 12 may be included in the operator terminal 6c. The configuration of the operator terminal 6c in this case may be such that the operator terminal 6c obtains information necessary to generate association information such as the contract address from the node computer 3a to generate association information and stores the generated association information into the memory 55. The configuration of the first contracting-party terminal 6a may be such that the first contracting-party terminal 6a transmits an address request to the operator terminal 6c and obtains the contract address of the smart contract associated with a desired contract identification name from the operator terminal 6c.

Although in the above embodiment, the platform of the blockchain network 2 is based on Ethereum, the platform is not limited to this but may be any platform based on EOS, Ripple, Quorum, or the like.

### 5. Configurations Supported by Embodiments Described Above

The above embodiments support the following configurations.

(Configuration 1) A contract management system including a plurality of computers that operate such that each computer holds the same distributed ledger and a plurality of terminal apparatuses, the contract management system including: a ledger management unit that receives transaction data and records a block including the received transaction data in the distributed ledger; and an association-information management unit that, when the ledger management unit records in the distributed ledger a block including transaction data including a smart contract for execution of a contract, generates association information that associates a contract address where the smart contract is stored with contract identification information for identifying the contract.

With the contract management system of configuration 1, since the contract address of the latest smart contract to be used for executing the contract is clearly indicated by the association information, the terminal apparatus, for example, can easily obtain the latest contract address. Hence, even in the case in which the smart contract is frequently changed along with changes in the contract conditions, it is possible to achieve a highly convenient contract management system in which increase in the number of manual operations on the above terminal apparatus by the user is prevented.

(Configuration 2) The contract management system according to configuration 1, in which the association-information management unit, when receiving a deletion instruction to delete the association information from one of the terminal apparatuses, deletes the association information specified by the deletion instruction, when receiving an invalidation instruction to invalidate the association information from the one terminal apparatus, invalidates the association information specified by the invalidation instruction, and/or when receiving a validation instruction to validate the association information from the one terminal apparatus, validates the association information specified by the validation instruction.

In the contract management system of configuration 2, it is easy to manage smart contracts because it is possible by deleting, validating, or invalidating association information to practically discard a smart contract generated in the past or validate one of the smart contracts invalidated in the past to reuse it as a smart contract to be used at present,

(Configuration 3) The contract management system according to configuration 2, in which when the association-information management unit generates, deletes, invalidates, or validates the association information, the association-information management unit generates transaction data on the generation, deletion, invalidation, or validation of the association information, and the ledger management unit records a block including the generated transaction data in the distributed ledger.

With the contract management system of configuration 3, since also the association information is recorded in the blockchain, it is possible to achieve high reliability in smart contract management using association information.

(Configuration 4) The contract management system according to configuration 2 or 3, in which the one terminal apparatus is an operator terminal apparatus that is operated by an operator certified for management of the smart contract.

With the contract management system of configuration 4, since association information is generated, deleted, invalidated, or validated via the terminal apparatus of a certified operator, it is possible to further increase the reliability of association information.

(Configuration 5) The contract management system according to any one of configurations 1 to 4, in which the association-information management unit transmits a contract address of a valid smart contract to be used for executing the contract to the terminal apparatus seeking to execute the contract, based on the association information.

With the contract management system of configuration 5, since the terminal apparatus seeking to execute the contract can directly obtain the contract address of the latest smart contract to be used for executing the contract from the association-information management unit, it is possible to decrease the number of user operations, prevent the occurrence of data falsification or the like somewhere along the communication route, and thus achieve execution of further reliable smart contracts.

(Configuration 6) The contract management system according to configuration 5, in which the smart contract is on a contract for electric power transaction by charging and discharging a battery mounted on a vehicle, and the terminal apparatus seeking to execute the contract is a mobile terminal owned by a user of the vehicle or a terminal apparatus mounted on the vehicle.

With the contract management system of configuration 6, it is possible to execute the electric-power transaction contract using a vehicle with easy operation by using a mobile terminal or an in-vehicle terminal apparatus.

(Configuration 7) A contract management method performed by a contract management system including a plurality of computers that operate such that each computer holds the same distributed ledger and a plurality of terminal apparatuses, the contract management method including: recording in the distributed ledger a block including transaction data including a smart contract for execution of a contract; and generating association information that associates a contract address where the smart contract is stored with contract identification information for identifying the contract, and storing the generated association information.

With the contract management method of configuration 7, since the contract address of the latest smart contract to be used for executing the contract is clearly indicated by the association information, the terminal apparatus, for example, can easily obtain the latest contract address. Hence, even in the case in which the smart contract is frequently changed along with changes in the contract conditions, it is possible to achieve a highly convenient contract management system in which increase in the number of manual operations on the above terminal apparatus by the user is prevented.

### REFERENCE SIGNS LIST

1 contract management system
2 blockchain network
3, 3a, 3b, 3c, 3d, 3e node computer
4 communication network
5 vehicle
6 terminal apparatus
6a first contracting-party terminal
6b second contracting-party terminal
6c operator terminal
7 electric power network
10, 30, 40, 50 processor
11 ledger management unit
12 association-information management unit
13 contract execution unit
20, 35, 45, 55 memory
21 distributed ledger
22 association information DB
31 contract management unit
32 address request unit
33 execution instruction unit
36, 46, 56 HID
41 contract generation unit
42 valid-contract selecting unit
51 acceptance unit
52 registration unit

What is claimed is:

1. A contract management system including a plurality of computers that operate such that each computer holds the same distributed ledger and a plurality of terminal apparatuses, the contract management system comprising:
a ledger management unit that receives transaction data and records a block including the received transaction data in the distributed ledger; and
an association-information management unit that, when the ledger management unit records in the distributed ledger a block including transaction data including a smart contract for execution of a contract, generates association information that associates a contract address where the smart contract is stored with contract identification information for identifying the contract.

2. The contract management system according to claim 1, wherein
the association-information management unit,
when receiving a deletion instruction to delete the association information from one of the terminal apparatuses, deletes the association information specified by the deletion instruction,
when receiving an invalidation instruction to invalidate the association information from the one terminal apparatus, invalidates the association information specified by the invalidation instruction, and/or
when receiving a validation instruction to validate the association information from the one terminal apparatus, validates the association information specified by the validation instruction.

3. The contract management system according to claim 2, wherein
when the association-information management unit generates, deletes, invalidates, or validates the association information, the association-information management unit generates transaction data on the generation, deletion, invalidation, or validation of the association information, and
the ledger management unit records a block including the generated transaction data in the distributed ledger.

4. The contract management system according to claim 2, wherein
the one terminal apparatus is an operator terminal apparatus that is operated by an operator certified for management of the smart contract.

5. The contract management system according to claim 1, wherein
the association-information management unit transmits a contract address of a valid smart contract to be used for executing the contract to the terminal apparatus seeking to execute the contract, based on the association information.

6. The contract management system according to claim 5, wherein
the smart contract is on a contract for electric power transaction by charging and discharging a battery mounted on a vehicle, and
the terminal apparatus seeking to execute the contract is a mobile terminal owned by a user of the vehicle or a terminal apparatus mounted on the vehicle.

7. A contract management method performed by a contract management system including a plurality of computers that operate such that each computer holds the same distributed ledger and a plurality of terminal apparatuses, the contract management method comprising:
recording in the distributed ledger a block including transaction data including a smart contract for execution of a contract; and
generating association information that associates a contract address where the smart contract is stored with contract identification information for identifying the contract, and storing the generated association information.
